(19) United States
(12) Patent Application Publication
(10) Pub. No.: US 2013/0192812 A1
(43) Pub. Date: Aug. 1, 2013

(54) HEAT EXCHANGER WITH DIE-CAST ELEMENTS AND METHOD FOR MANUFACTURING THE SAME

(71) Applicant: Mario Morini, Broni (IT)

(72) Inventor: Mario Morini, Broni (IT)

(73) Assignee: Unical AG S.P.A

(21) Appl. No.: 13/877,098

(22) PCT Filed: Jun. 8, 2011
(86) PCT No.: PCT/EP2011/059470

§ 371 Date: Mar. 29, 2013

(30) Foreign Application Priority Data
Oct. 1, 2010 (IT) MI2010A001804

(51) Int. Cl. F28F 21/08; B23P 15/26

(52) U.S. Cl. CPC F28F 21/084; B23P 15/26
USPC 165/177; 29/890.03

(57) ABSTRACT

A method for manufacturing a heat exchanger with die-cast elements, comprising a die-casting step for die-casting at least one element of a heat exchanger by means of at least one die, further comprising a positioning step for positioning at least one contoured duct inside the die, performed prior to the die-casting step.

The present invention relates to a method for manufacturing a heat exchanger with die-cast elements and to a heat exchanger obtained from the method.

Heat exchangers are known which are manufactured from die-cast elements whose number can vary according to the heating power levels that the heat exchanger must reach.

In its minimum configuration, a heat exchanger with die-cast elements is provided by a die-cast element that is crossed by a duct in which the fluid with which heat exchange is to be performed flows.

In conventional heat exchangers, such duct is provided by a plurality of first metallic tubular elements, having a rectilinear shape, which are inserted in the die-cast element so as to be parallel to each other, and by a plurality of second metallic tubular elements, having a curvilinear shape, which are external with respect to the die-cast element and are welded to the first metallic elements at their ends, so as to provide a continuous duct that passes repeatedly through the die-cast element.

Generally, the method for manufacturing a conventional heat exchanger with die-cast elements provides for the manufacture of the individual die-cast element by means of a step of die-casting in a die in which multiple cores, adapted to define the passage holes of the first tubular elements, are inserted.

Once die-casting has been achieved, such cores are removed and the first tubular elements are inserted in their place and then connected to each other by means of the second tubular elements and are fixed to them by welding.

These conventional heat exchangers with die-cast elements are not devoid of drawbacks, which include the fact that since the duct is crossed by a pressurized fluid which sometimes is also corrosive, the welding beads that are present between one duct portion and the other do not ensure a correct hydraulic seal of the duct.

Moreover, another drawback of conventional heat exchangers resides in that they have a low thermal efficiency with respect to the ideal one, since the duct has portions which are external to the die-cast element which not only do not contribute to the exchange of heat but also cause dissipation of the heat.

The aim of the present invention is to provide a method for manufacturing a heat exchanger with die-cast elements that allows to obtain heat exchangers that solve and overcome, respectively, the drawbacks and limitations of the background art.

Within this aim, an object of the present invention is to provide a manufacturing method that is economically competitive with respect to the one used in the background art.

This aim and these and other objects that will become better apparent hereinafter are achieved by a method for manufacturing a heat exchanger with die-cast elements, comprising a die-casting step for die-casting at least one element of a heat exchanger by means of at least one die, characterized in that it comprises a positioning step for positioning at least one contoured duct inside said die, performed prior to said die-casting step.

Moreover, this aim and these and other objects which will become better apparent hereinafter are achieved by a heat exchanger comprising at least one die-cast element, characterized in that it comprises, completely inside said die-cast element, at least one contoured duct provided by a single metal tube.

Further characteristics and advantages of the present invention will become better apparent from the description of a preferred but not exclusive embodiment of a heat exchanger and of a method for manufacturing a heat exchanger with die-cast elements, according to the invention, illustrated by way of non-limiting example in the accompanying drawings, wherein:

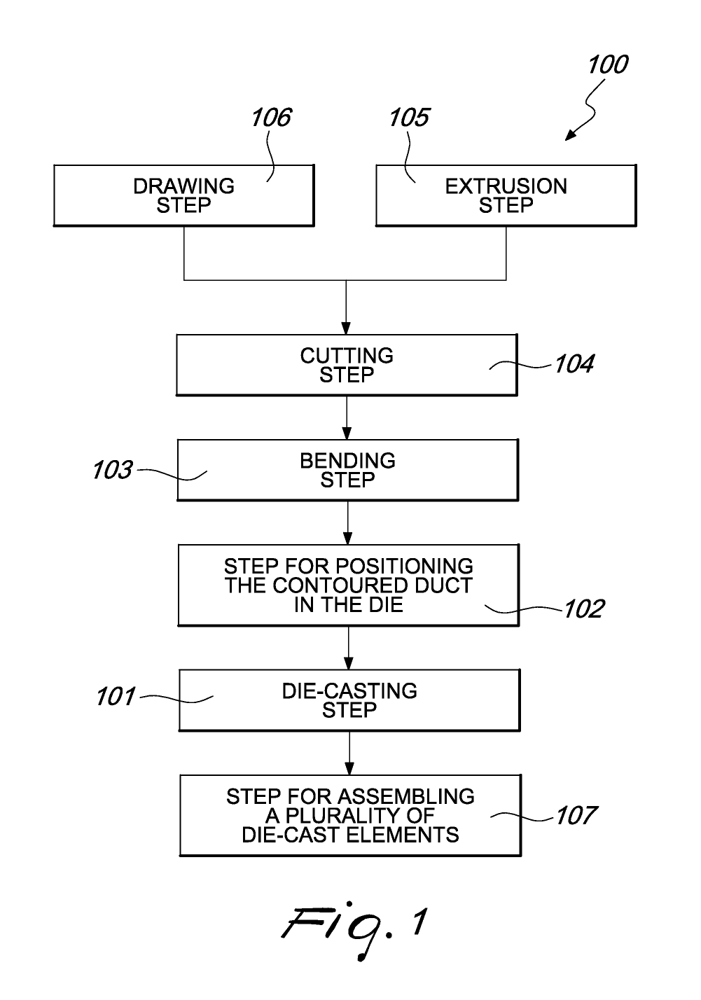

FIG. 1 is a block diagram of the method for manufacturing a heat exchanger with die-cast elements, according to the invention;

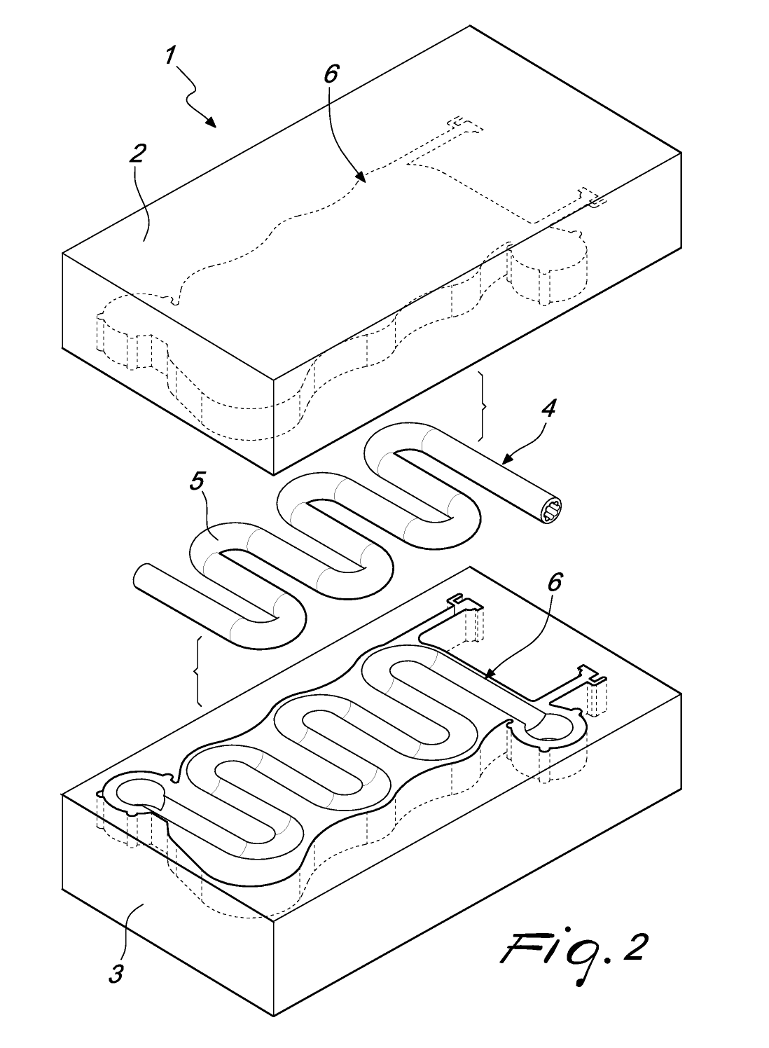

FIG. 2 is a schematic exploded view of the die used by the method shown schematically in FIG. 1 to manufacture a heat exchanger with die-cast elements, according to the invention.

With reference to the figures, the method for providing a heat exchanger with die-cast elements, generally designated by the reference numeral 100, comprises a step 101 of die-casting at least one element of a heat exchanger by means of at least one die 1 provided by two die parts 2 and 3, respectively an upper one and a lower one.

In greater detail, the two die parts 2 and 3 define the form 6 in which die-casting occurs and in which, according to the invention, at least one contoured duct 4 is placed by means of an adapted positioning step 102 performed prior to the die-casting step.

More precisely, the contoured duct 4 is obtained by means of a bending step 103, preceded by a cutting step 104, of a metallic tube 5 made of aluminum, which is obtained by means of a step of extrusion 105 or drawing 106.

In this manner, the contoured duct 4 is accommodated completely inside the die-cast element and is provided before performing die-casting, so as to not require additional working for completion performed after the die-casting step.

More precisely, the use of aluminum both to provide the metallic tube 5, which can have inner fins to increase the heat exchange surface, and for the die-casting step 101 entails particular solutions in the design of the die and during the die-casting step 101.

First of all, the two die parts 2 and 3 must have a plurality of alternating casting connections to the metallic tube 5, since the molten material under pressure must not strike it directly, in order to avoid denting, deforming or melting it.

Moreover, in order to facilitate the grip of the molten material it is possible to heat the metallic tube 5 to approximately 80-100° C.

If necessary, the metallic tube 5 can be cooled by means of the internal circulation of liquid (nitrogen, water, oil, etc.).

After obtaining the die-cast element which, depending on the heating power required to the heat exchanger can be a right, left or intermediate element, one proceeds with the step 107 of assembly of a plurality of die-cast elements whose number is variable according to the design specifications of the desired power levels.

In this manner it is possible to provide a heat exchanger that comprises a plurality of die-cast elements which are associated with each other, or at least one die-east element, each having internally at least one contoured duct 4 provided by a single metallic tube 5.

In practice it has been found that the method for providing a heat exchanger with die-cast elements, according to the present invention, fully achieves the intended aim and objects, since it allows to obtain heat exchangers obtained from die-cast elements that accommodate inside them contoured ducts which have no welds, so as to ensure a perfect hydraulic seal.

Another advantage of the method according to the present invention resides in that it is economically competitive if compared with the background art, since once the die-casting step has been performed the contoured duct requires no further completion work.

The method for manufacturing a heat exchanger with die-east elements and the heat exchanger that can be manufactured with it, thus conceived, are susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements and to the state of the art.

The disclosures in Italian Patent Application No. MI2010A001804 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-9. (canceled)

10. A method for manufacturing a heat exchanger with die-cast elements, comprising a die-casting step for die-casting at least one element of a heat exchanger by means of at least one die, further comprising a positioning step for positioning at least one contoured duct inside said die, performed prior to said die-casting step.

11. The method according to claim 10, further comprising an extrusion step for extrusion of a metal tube to provide said contoured duct, said extrusion step being performed prior to said positioning step.

12. The method according to claim 10, further comprising a drawing step for drawing a metal tube to provide said contoured duct, said drawing step being performed prior to said positioning step.

13. The method according to claim 12, further comprising a cutting step for cutting said extruded or drawn metal tube, said cutting step being performed after said extrusion step or after said drawing step and prior to said positioning step.

14. The method according to claim 13, further comprising a bending step for bending a cut metal tube, said bending step being performed after said cutting step and prior to said positioning step.

15. The method according to claim 10, further comprising an assembling step for assembling a plurality of die-cast elements obtained from said die-casting step to provide said heat exchanger.

16. A heat exchanger, comprising at least one die-cast element, comprising, completely inside said die-cast element, at least one contoured duct, which is provided by a single metal tube.

17. The heat exchanger according to claim 16, further comprising a plurality of die-cast elements, which are mutually associated and have inside them at least one contoured duct provided by a single metal tube.

18. The heat exchanger according to claim 17, wherein said metal tube is made of aluminum.
